(19) United States
(12) Patent Application Publication
(10) Pub. No.: US 2001/0038266 A1
(43) Pub. Date: Nov. 8, 2001

(54) Electric lamp

(76) Inventors: Johannes Andreas Zaat, Weert (NL); Jozef Johannes Cornelis Buelens, Eindhoven (NL)

Correspondence Address: Michael E. Marion, U.S. Philips Corporation, 580 White Plains Road, Tarrytown, NY, 10591, US

(21) Appl. No.: 09/817,085

(22) Filed: Mar. 26, 2001

(30) Foreign Application Priority Data
Mar. 28, 2000 (EP) 00201114.6

(51) Int. Cl. H01J 17/20; H01J 17/04

(52) U.S. Cl. 313/633; 313/575

(57) ABSTRACT

An electric lamp with a simple welding/brazing connection comprises an electric element (2) in a translucent lamp vessel (1) with current supply conductors (4, 5) and a lamp cap (6) connected to the vessel (1) and having a shell portion (7) and a base portion (8) carrying an electric contact (9). The current supply conductor (4, 5) passes through the surface of this contact (9) to the exterior and is welded/brazed to it by means of a solidified connection body (10) of aluminum with a dope of silicon in an amount ranging from 5 to 16 % weight.

The invention relates to an electric lamp comprising

a light-transmitting lamp vessel,

an electric element in the lamp vessel,

current supply conductors extending to the electric element,

a lamp cap connected to the lamp vessel, which lamp cap has a shell portion and a base portion which each support an electric contact member, each electric contact member having a surface on which the respective current supply conductor is fastened by means of a solidified connection body comprising aluminum and an additive.

Such an electric lamp is known, for example, from EP-406 948 B1.

The known lamp has a lamp cap with a conventional flat plate which is anchored in the base portion as a contact member through which a current supply conductor issues to the exterior. In the known lamp, the connection body is a droplet of metal, of aluminum, by means of which the current supply conductor was fixed to the plate in a welding operation. The aluminum metal droplet may comprise, for example, iron or manganese, as a metal additive. A disadvantage of the known lamp is that the aluminum metal droplet, whether or not comprising such an additive, has a melting point which is comparatively high compared with the melting point of the shell portion. When a welded/brazed joint is made between a further current supply conductor and a further contact member of the shell portion, for example made of aluminum or alloys thereof, the further contact member and/or current supply conductor is thermally comparatively strongly loaded when a metal droplet having a comparatively high melting point is used. Given such a high thermal load, there is the risk of a bad electrical contact between the current supply conductor and the plate of the contact member, and there is also a risk of local deformation and/or melting of the base portion.

The invention has for its object to provide a lamp of the kind described in the opening paragraph in which the above disadvantages are counteracted.

To achieve this object, the electric lamp of the kind described in the opening paragraph is characterized in that the additive comprises 5 to 16% by weight of silicon. The addition of silicon in a quantity of 5 to 16% by weight to the aluminum, referred to as AlSi for short, has the advantage that the connection body has a melting point which is at least 30° C. lower than the melting point of aluminum of, for example, the shell portion. Such a lower melting point is favorable because the welding/brazing joint can be made in a process at comparatively low temperatures, so that the risk of rejects during lamp assembly is reduced. In addition, AlSi has the advantage that it was found to be comparatively well-resistant to electrochemical corrosion. AlSi also has the advantage that a good adhesion/wetting of the connection body made of this material with respect to the base portion and the shell portion, for example made of aluminum, is achieved. A robust connection of the current supply conductor to the contact member of the shell portion can thus be realized with AlSi. In addition, aluminum and silicon have the advantage that both materials are comparatively inexpensive. The AlSi may comprise small quantities, for example up to 0.6% by weight, of impurities or additives such as Ti, Mn, Mg, Zn, Cu, and Fe, which do not detract from the favorable properties of the welded/brazed joint and which in some cases may achieve a further lowering of the melting point of AlSi. The lamp cap of the lamp according to the invention may be a conventional Edison or a conventional Swan lamp cap with a conventional flat plate as the contact member, anchored in the base portion of the lamp cap. Both the plate and the shell portion of the lamp cap may be made of a conventional material, such as aluminum, aluminum alloys, brass, or nickel-plated brass.

Preferably, the silicon additive accounts for a quantity of 11 to 13.5% by weight. The AlSi then complies with DIN 1732, and the addition of silicon to aluminum in this quantity leads to a connection body with a melting point which is at least 60° C. lower than the melting point of aluminum. The melting point of such a connection body is 600° C. or less, whereby the risk of rejects during the creation of the welded joint in lamp assembly is further reduced.

Aluminum forms a eutectic mixture with silicon, a lowest melting point of the eutectic mixture of approximately 577° C. being reached for a quantity of Si in Al of approximately 12.5% by weight. This eutectic mixture is generally known as AlSi12. Compared with conventional solders comprising heavy metal, for example lead-tin solders melting at comparatively very low temperatures, for example Pb 70%-Sn 30% by weight with a melting range from 185 to 257° C., AlSi12 is highly suitable for applications at comparatively high temperatures because of its comparatively high melting point. AlSi12 is also highly suitable for lamps with shell portions made of aluminum where, in contrast to soldering, a fusion takes place between the connection body and the shell portion at the boundary surface. Since the melting point of AlSi12 is significantly lower than that of aluminum, i.e. 577° C. and 660° C., respectively, there is at least substantially no risk of an unacceptably high degree of fusion of the shell portion.

Techniques which may be used for connecting the current conductor to the contact element by means of AlSi are, for example, torch welding, laser welding, and brazing by means of flames and a brazing flux. The connection body has a temperature approximately equal to the melting temperature of the material of the shell portion at the moment of joining together, but the connection body has only a limited volume at accordingly a limited heat content. As a result, the current supply conductor will have been thermally loaded to a limited extent only, and the risk of fracture of the current supply conductor, owing to the fact that the latter was not or hardly recrystallized, is reduced. The thermal load on said conductor will have been much greater in a welded joint obtained by a conventional connection method, for example through the application of an electric arc to the current supply conductor and melting of this conductor without the use of a supplied additional material. Moreover, there is only a very small contact surface area between the current supply conductor and the electric contact member because no supplied material was used. This means that the conventional method involves a considerable risk of a bad electrical contact between the current supply conductor and the electric contact member, and a subsequent interruption of this electrical contact.

It is obvious that the type of electric lamp is immaterial to the essence of the invention. The lamp may be an electric discharge lamp or an incandescent lamp. The electric element, an incandescent body in the case of an incandescent lamp, may be enclosed in an inner envelope in the lamp vessel. In the case of a halogen incandescent lamp, the lamp vessel, i.e. the inner envelope, if present, will contain a filling comprising a halogen. An inner envelope will usually be present if the electric element is a pair of electrodes in an ionizable gas. The lamp vessel may be partly reflectorized. Alternatively, the lamp vessel may be connected to a reflector body which partly surrounds the lamp vessel.

Embodiments of the lamp according to the invention are shown in the drawing, in which

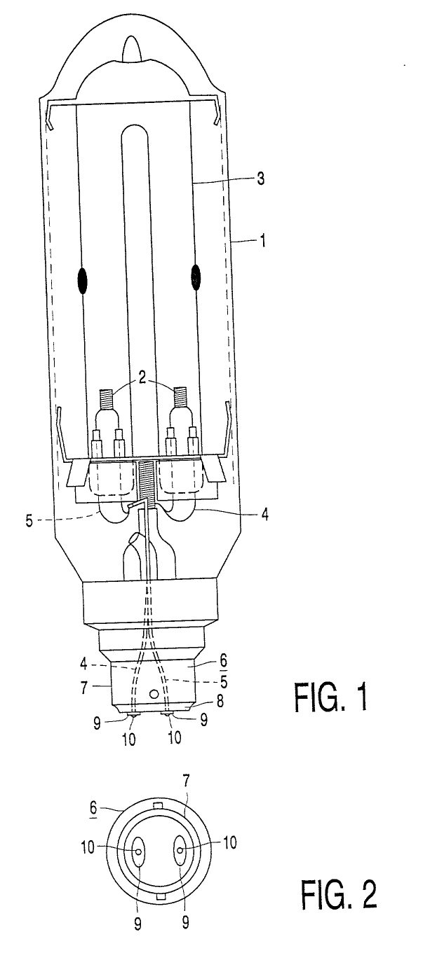

FIG. 1 shows a discharge lamp in side elevation,

FIG. 2 is an elevation of the base portion of the lamp cap of FIG. 1,

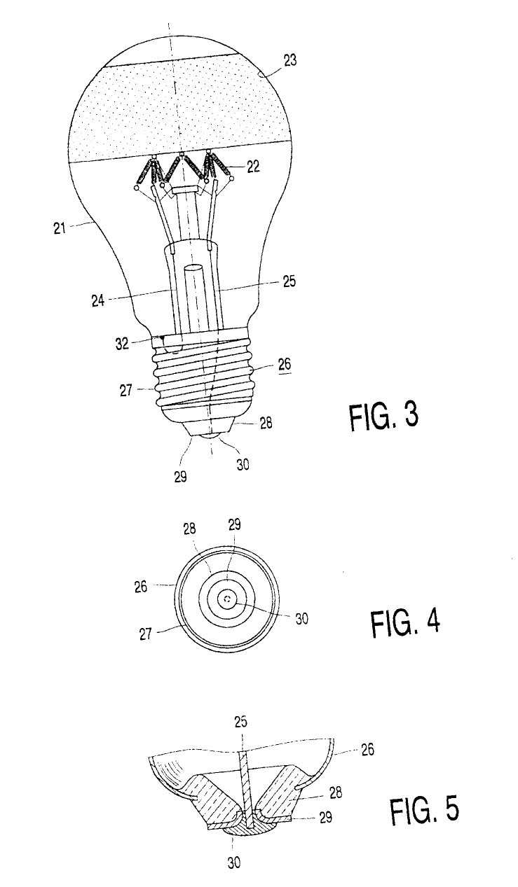

FIG. 3 shows an incandescent lamp in side elevation,

FIG. 4 is an elevation of the base portion of the lamp cap of FIG. 3, and

FIG. 5 is a cross-sectional view of the lamp cap of FIGS. 3 and 4 on an enlarged scale.

The lamp of FIG. 1 has a light-transmitting lamp vessel 1 in which an electric element 2, a pair of electrodes, is arranged. The pair of electrodes in the Figure is surrounded by an inner envelope 3 which is filled with an ionizable gas such as neon/argon and sodium vapor. Current supply conductors 4, 5 extend to the electric element 2. A lamp cap 6 having a shell portion 7 and a base portion 8 supporting an electric contact member 9 is connected to the lamp vessel 1. The electric contact member 9 has a surface through which a current supply conductor 4, 5 issues to the exterior and on which said current supply conductor is secured.

In the Figure, the base portion 8 of the lamp cap 6 has two contact members 9 (see also FIG. 2), each comprising a flat, oval brass plate. The lamp cap 6 shown is a conventional lamp cap with B-22 fit and conventional contact members 9. The current supply conductors 4, 5 shown are made of copper at the areas of the contact members 9.

In FIGS. 1 and 2, the current supply conductor 4, 5 is retained to the surface of the respective contact member 9 by means of a solidified connection body 10 substantially made of aluminum with 5 to 16% by weight of an additive, i.e. of Si.

The solidified connection body 10 in the lamp as drawn comprises aluminum with 10% by weight of silicon added thereto. The connection body 10 is in contact with the corresponding contact member 9 substantially with a circular boundary.

In FIGS. 3, 4, and 5, reference numerals indicating components corresponding to those in FIGS. 1 and 2 are 20 higher than in FIGS. 1 and 2. The electric element 22 of the lamp shown is an incandescent body, the lamp cap 26 is a conventional E27 lamp cap with a flat brass plate 29 as the contact member on the base portion 28. The connection body 30 is made of a eutectic mixture AlSi12, i.e. aluminum with 12.5% by weight of silicon as the additive, and has a flattened shape with a hemispherically curved free surface and with a substantially circular contact surface for the contact member 29. A skin of the contact member was melted at said contact surface and fused to the connection body 30. The same is true for a skin of the current supply conductor 25, comprising 28.5% Cu, 68.5% Ni, 1.5% Fe, and 1.5% Mn by weight and acting as a fuse in this location, which was liquefied and fused to the connection body. The current supply conductor 24 is fastened to the shell 27 of the lamp cap 26 in a location 32 by means of a solidified connection body 32 of aluminum with 12.5% by weight of silicon as the additive. This connection wire is also a fuse wire, for example having the same composition as the current supply conductor 25. The shell 27 of the lamp cap 26 is made of aluminum, but it may alternatively be made of, for example, brass, nickel-plated brass, etc. The shell 27 of the lamp cap 26 was only superficially fused at the area of the contact surface owing to the connection body 32 being provided thereon and was not deformed, and the skin of the current supply conductor 24 was similarly fused to the connection body 32. The connection technique used was brazing with a hydrogen microflame (commercially known as SPIR flame), and the brazing flux used for this was Castolin 190. The lamp vessel 21 has a partial reflectorization 23.

1. An electric lamp comprising
a light-transmitting lamp vessel (1),
an electric element (2) in the lamp vessel (1),
current supply conductors (4, 5) extending to the electric element (2),
a lamp cap (6) connected to the lamp vessel (1), which lamp cap (6) has a shell portion (7) and a base portion (8) which each support an electric contact member (9), each electric contact member (9) having a surface on which the respective current supply conductor is fastened by means of a solidified connection body (10) comprising aluminum and an additive,
characterized in that said additive comprises 5 to 16% by weight of silicon.

2. An electric lamp as claimed in claim 1, characterized in that said additive comprises 11 to 13.5% by weight of silicon.

3. An electric lamp as claimed in claim 1, characterized in that the connection body (10) comprises a eutectic mixture of aluminum with approximately 12.5% by weight of silicon.
